(19) United States
(12) Patent Application Publication
(10) Pub. No.: US 2024/0300786 A1
(43) Pub. Date: Sep. 12, 2024

(54) MOTORIZED DESCENT FOR POWERED ASCENDERS

(71) Applicant: Atlas Devices LLC, Chelmsford, MA (US)

(72) Inventors: Nathan Ball, Forest Grove, OR (US); Daniel Walker, Melrose, MA (US)

(21) Appl. No.: 18/597,888

(22) Filed: Mar. 6, 2024

Related U.S. Application Data
(60) Provisional application No. 63/450,179, filed on Mar. 6, 2023.

(51) Int. Cl. B66D 5/16; A62B 1/14; B66D 1/12; B66D 1/74

(52) U.S. Cl. CPC B66D 5/16; A62B 1/14; B66D 1/12; B66D 1/7489

(57) ABSTRACT

A powered ascender has a motor, a brake assembly, and a gearbox. The gearbox is mechanically coupled between the motor and the brake assembly. The brake assembly applies a maximum braking force while the motor is not rotating. The brake assembly applies a lesser braking force in response to the motor rotating in a reverse direction.

### PRIORITY

This patent application claims priority from provisional U.S. patent application No. 63/450,179, filed Mar. 6, 2023, entitled, “MOTORIZED DESCENT OR POWERED ASCENDERS,” and naming Nathan Ball et al. as inventors, the disclosure of which is incorporated herein, in its entirety, by reference.

### FIELD

Illustrative embodiments of the invention generally relate to powered ascenders and, more particularly, various embodiments of the invention relate to motor-controlled descent for powered ascenders.

### BACKGROUND

Powered ascenders move loads by ascending and descending a cordage. The powered ascender may descend the cordage at a controlled rate by applying a braking force.

### SUMMARY OF VARIOUS EMBODIMENTS

In accordance with one embodiment of the invention, a powered ascender has a motor, a brake assembly, and a gearbox. The gearbox is mechanically coupled between the motor and the brake assembly. The brake assembly applies a maximum braking force while the motor is not rotating. The brake assembly applies a lesser braking force in response to the motor rotating in a reverse direction.

In some embodiments, the powered ascender has a motor mount configured to rotate in the reverse direction in response to the motor rotating in the reverse direction.

The magnitude of the lesser braking force may be proportional to a reaction torque of the reverse rotation of the motor.

In some embodiments, the brake assembly has a gear assembly coupled to the motor mount and a clamp bar coupled to the gear assembly. The gear assembly may rotate the clamp bar in response to the motor mount rotation.

In some embodiments, the powered ascender has a pulley to apply a force to a cordage proportional to a weight of a load coupled to the powered ascender.

In some embodiments, the powered ascender has a driveshaft, a pulley; and a clutch coupled to the driveshaft and configured to selectively engage the pulley. The powered ascender may also include a second clutch coupled to the braking assembly and configured to selectively engage the pulley. The pulley may engage the second clutch and disengage from the first clutch when the motor is not rotating. The pulley may disengage from the second clutch and engage the first clutch when the motor is rotating in a forward direction.

In accordance with another embodiment, a method for operating a powered ascender rotates a motor in a forward direction, the motor being coupled to a gearbox. The method then stops the motor. The method applies, using a brake assembly, a maximum braking force to a cordage. The method then rotates the motor in a reverse direction. The method applies, using the brake assembly, a lesser braking force after rotating the motor in the reverse direction.

Applying the lesser braking force may include rotating a motor mount in the reverse direction. The magnitude of the lesser braking force may be proportional to an angular displacement of the rotation of the motor mount.

The brake assembly of the powered ascender may include a gear assembly coupled to the motor mount and a clamp bar coupled to the gear assembly. Applying the lesser braking force may include rotating the clamp bar using the gear assembly.

Applying the lesser braking force may include decreasing a magnitude of the lesser braking force by increasing a rotational force of the motor in the reverse direction.

In some embodiments, the powered ascender includes a driveshaft, a pulley, and a clutch coupled to the driveshaft and configured to selectively engage the pulley. The powered ascender may include a second clutch coupled to the braking assembly and configured to selectively engage the pulley.

Applying the maximum braking force may include engaging the pulley and the second clutch, and disengaging the pulley and the first clutch. Rotating the motor in the forward direction may include disengaging the pulley and the second clutch and engaging the first clutch and the pulley.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIGS. 1A-1F are views schematically showing a powered ascender in accordance with various embodiments.

FIGS. 2A-2B are views schematically showing the powered ascender in accordance with various embodiments.

FIGS. 3A-3B are views schematically showing the powered ascender in accordance with various embodiments.

FIG. 4 is a flowchart showing a process for operating the powered ascender in accordance with various embodiments.

FIG. 5 is a box diagram showing a controller of the powered ascender in accordance with various embodiments.

### DESCRIPTION OF ILLUSTRATIVE EMBODIMENTS

In illustrative embodiments, a powered ascender is ascends a cordage by rotating an electric motor in one direction and descends the cordage by rotating the electric motor in the opposite direction. Rotating the electric motor in the opposite direction exerts a force on a brake assembly decreasing the braking force exerted on the cordage, allowing the powered ascender to descend and control the rate of descent. The force applied to the brake assembly is inversely proportional to a braking force applied to the cordage. Details of illustrative embodiments are discussed below.

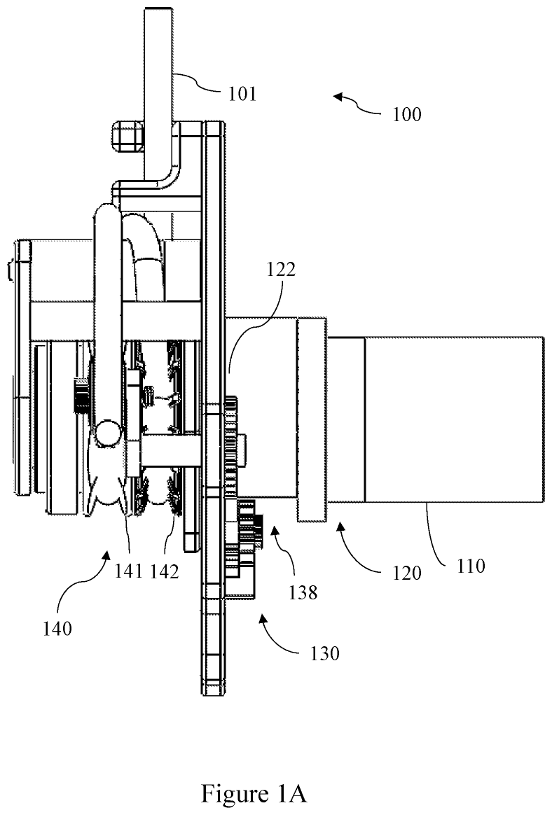

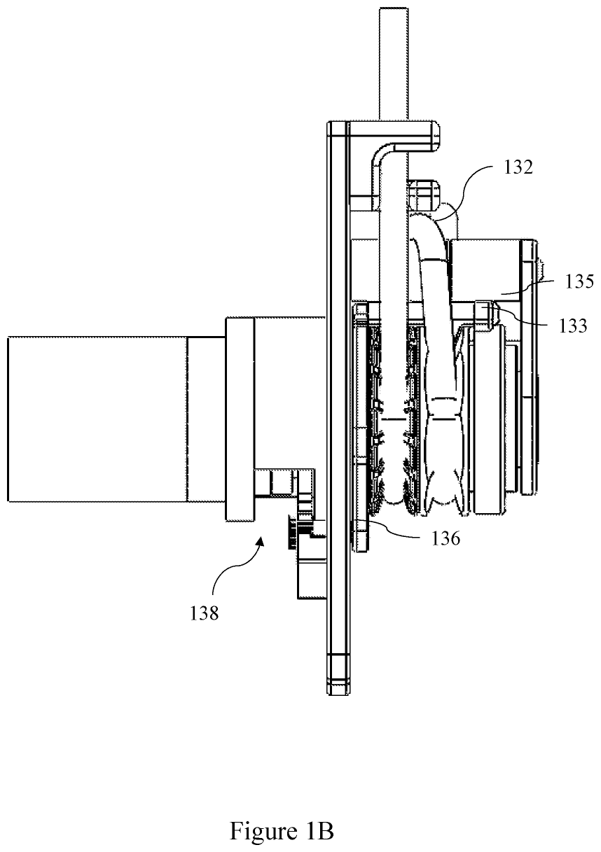

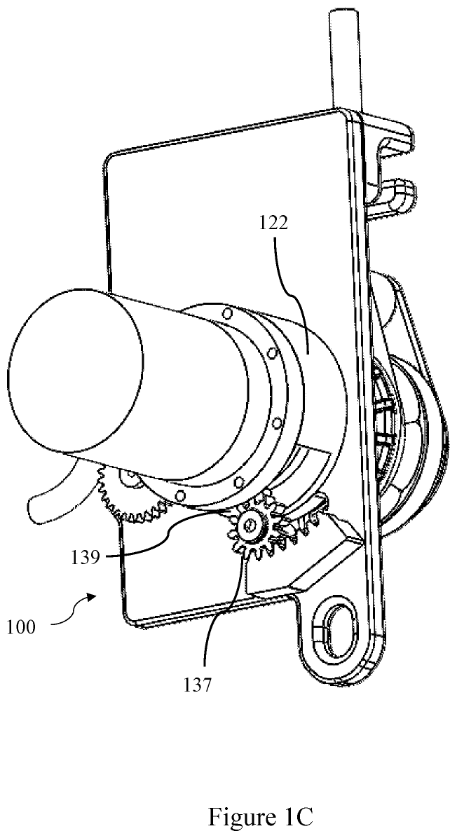

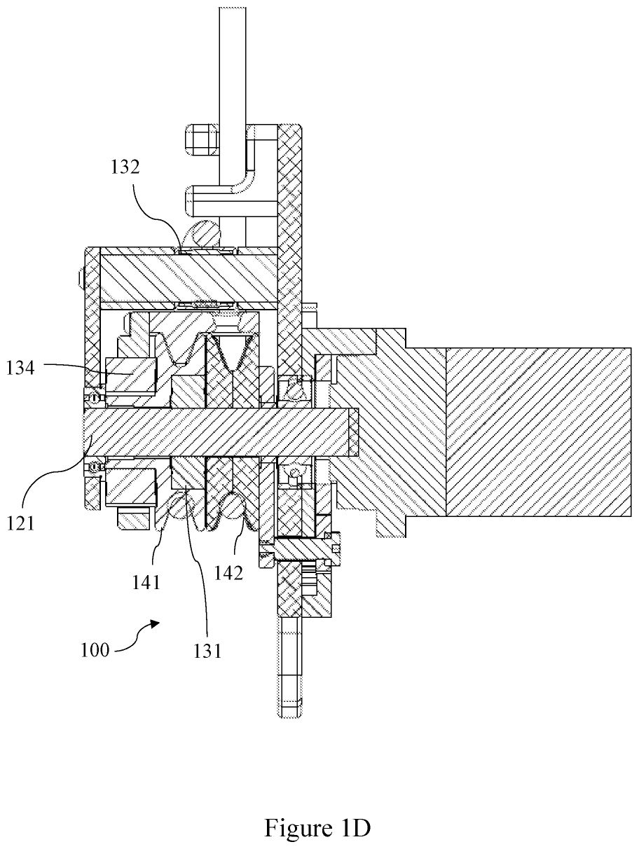

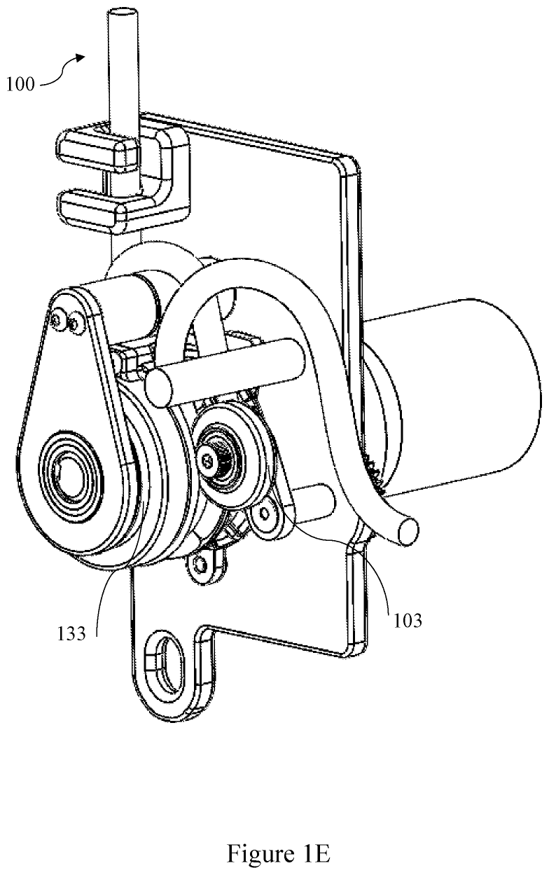

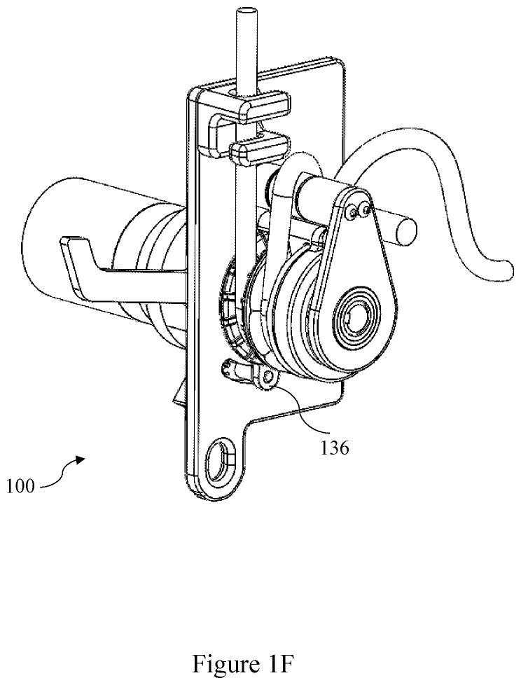

FIGS. 1A-1F schematically show a powered ascender 100 configured to ascend and descend a cordage 101. The cordage 101 may include a rope, cord, twine, or cable, among other things. The powered ascender 100 has a motor 110 configured to rotate in a forward direction and a reverse direction. In the forward direction, the motor 110 exerts a rotational force causing the powered ascender 100 to ascend the cordage 101. In the reverse direction, the motor 110 exerts an opposite rotational force, causing the powered ascender to descend the cordage 101.

The powered ascender 100 has a gearbox 120 mechanically coupled to the output shaft of the motor 110. The gearbox 120 receives rotational force with an angular velocity, and outputs, with a driveshaft 121, a modified rotational force with a different angular velocity. For example, the gearbox 120 may be configured to reduce an angular velocity of the rotational force generated by the motor 110. The gearbox also has a motor mount 122 configured to rotate between two positions based on the direction of the rotational force output by the motor 110. For example, when the motor toggles between rotating in the forward direction and the reverse direction, the rotation of the motor 110 causes the motor mount 122 to rotate. It should be understood, that when the motor mount 122 rotates in the reverse direction, that is the direction to cause the powered ascender 100 to descend, the motor mount 122 may actually be rotating clock wise while the motor 110 is rotating counterclockwise, and vice versa.

The powered ascender 100 has a pulley system 140 configured to grip the cordage 101 and exert rotational force on the gripped cordage 101. In the illustrated embodiments, the pulley system 140 includes pulleys 141 and 142, but other embodiments may include a different number of pulleys. The pulley system may also include a different arrangement of pulleys, such as a vertical arrangement instead of the illustrated side-by-side arrangement. The pulley system 140 is coupled to the driveshaft 121. Specifically, the pulley 142 is coupled to the driveshaft 121 and rotates as the driveshaft 121 rotates. The pulley 141 is coupled to the driveshaft 121 indirectly such that the driveshaft 121 indirectly causes the pulley 141 to rotate while rotating in the forward direction. The pulley 141 will spin freely, or disengage from, the driveshaft when the motor 110 stops or the motor 110 rotates in the reverse direction.

The powered ascender 100 has a clip-in point 102 configured to be coupled to a load which is raised or lowered by the movement of the powered ascender 100. In the illustrated embodiment, the powered ascender includes an idler pulley 103 configured to push the cordage 101 into a pulley of the pulley system 140. The idler pulley 103 may be biased toward the pulley system by a spring or by a gear of the gearbox 120.

In some embodiments, the clip-in point 102 is coupled to a bar configured to rotate about a fixed midpoint. Coupled to the other end of the bar would be the idler pulley 103 configured to push the cordage 101 into the pulleys 140 as the bar rotates due to the weight of the load coupled to the clip-in point 102. The heavier the load, the greater the force applied by the idler pulley 103 to the cordage 101 into the pulleys 140.

The powered ascender 100 has a brake assembly 130 configured to apply a braking force to the cordage 101 while the powered ascender 100 is descending or the motor 110 is stopped. The brake assembly 130 has a clutch 131 configured to exert rotational force on the pulley 141 when the driveshaft 121 is rotating in the forward direction and spin freely when the cordage 101 exerts a force to spin the pulley 141 in the reverse direction. The clutch 131 may be a clutch bearing, a ratcheting mechanism, or another type of device structured to spin freely, or disengage, when receiving a rotational force in one direction, and engage, or lock, when receiving a rotational force in the other direction.

The brake assembly 130 has a clamp bar 133 and a stopper bar 135 configured to exert the braking force on the cordage 101 by rotating the clamp bar 133 towards the stopper bar 135. The brake assembly 130 has a clutch 134 configured to allow the clamp bar 133 to rotate towards the stopper bar 135 when the cordage 101 exerts a reverse rotational force on the pulley 141, such as when the motor has stopped while the powered ascender is suspended by the cordage 101. The clutch 134 is positioned around the exterior of an extended portion of the pulley 141 and coupled to the clamp bar 133. The clutch 134 exerts rotational force on the clamp bar 133 when the pulley 141 is rotating in reverse direction as the motor 110 is stopped. When the driveshaft 121 is rotating in the forward direction, the clutch 134 spins freely.

The brake assembly 130 has a clutch roller bearing 132 which resists movement of the cordage 101 while the powered ascender 100 is stopped or descending, and spins freely when the powered ascender 100 is ascending.

For the powered ascender 100 to ascend, the idler pulley 103 provides the initial torque required for the pulley system 140 to grip the cordage 101. The motor 110 rotates in the forward direction, rotating the driveshaft 121 and the pulley 142 fixed to the driveshaft. The clutch 131 engages the pulley 141 and the clutch roller bearing 132 spins freely while the cordage 101 slides along the outer surface of the clutch roller bearing 132.

To stop the powered ascender 100, the motor 110 stops rotating. Gravity causes the cordage 101 to exert force in the reverse direction on the clutches 131 and 134 by way of the pulley 141. The rotational force received by the clutch 134 rotates the clamp bar 133 towards the stopper bar 135, applying a maximum braking force, resisting the downward motion of the powered ascender 100. The downward motion of the powered ascender 100 is further resisted by the clutch roller bearing 132.

As the motor 110 rotates in the reverse direction, the brake assembly 130 reduces the braking force exerted on the cordage 101, allowing the powered ascender 100 to descend the cordage 101 at a controlled rate of descent. The more the motor 110 rotates in the reverse direction, the greater the reduction of the braking force.

In addition to the reverse rotation of the motor 110, the powered ascender 100 may use other components or arrangements to control the braking force. For example, the powered ascender 100 may include a slip clutch or rotary damper to allow rotation in one direction and allow locking in the reverse direction. The powered ascender may use magnetic drag or to rotate a clutch to control the braking force. In another example, motor 110 may have one set of stator windings to rotate the motor 110 in a forward direction, and a second set of stator windings to rotation the motor 110 in the reverse direction.

The brake assembly 130 is configured to control the descent of the powered ascender 100 using the force received as a result of rotating the motor 110 in the reverse direction. While the motor 110 is rotating in the reverse direction, the motor mount 122 of the gearbox 120 rotates until a protrusion of the motor mount 122 contacts a gear assembly 138 of the brake assembly 130. In the illustrated embodiment, the gear assembly includes a gear 139 coupled to the motor mount 122 which rotates as the motor mount 122 rotates. The gear assembly 138 also includes a ring gear 137 engaged with the gear 139 and coupled to a release arm, which is a part of the clamp bar 133. The gear 139 rotates from a biased position when contacted by the protrusion of the motor mount 122, rotating the ring gear 137 of the brake assembly 130. As the ring gear 137 rotates, the clamp bar 133 rotates away from the stopper bar 135 by way of the release arm 136 coupled to the clamp bar 133. As the clamp bar 133 rotates farther away from the stopper bar 135, braking force applied to the cordage 101 decreases.

In this way, operation of the motor 110 controls the ascent of the powered ascender 100 when rotating in the forward direction and controls the magnitude of the braking force exerted on the cordage 101 when rotating in the reverse direction. The magnitude of the braking force is proportional to the reaction torque of the motor 110 reverse rotation.

It should be appreciated that separate components, such as a solenoid, are not needed to control ascents or descents since the motor 110 provides both the rotational force to ascend and operates the brake assembly 130 for controlled descent.

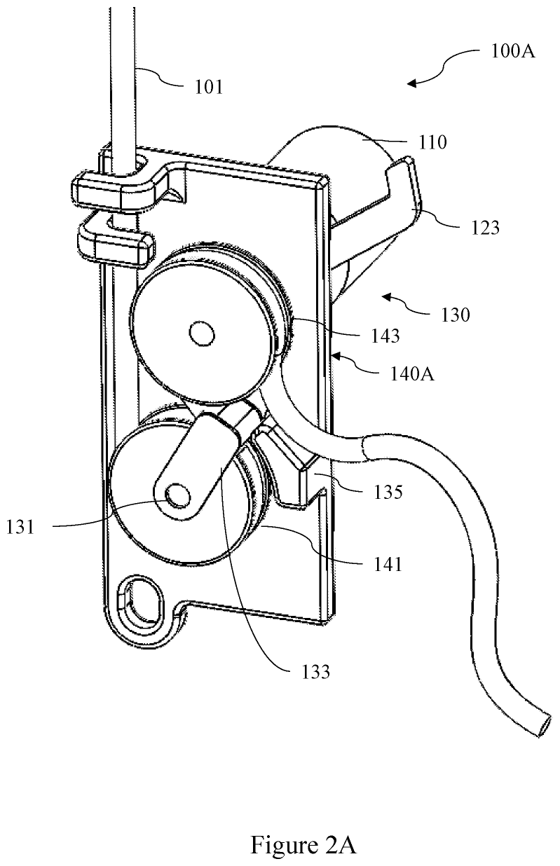

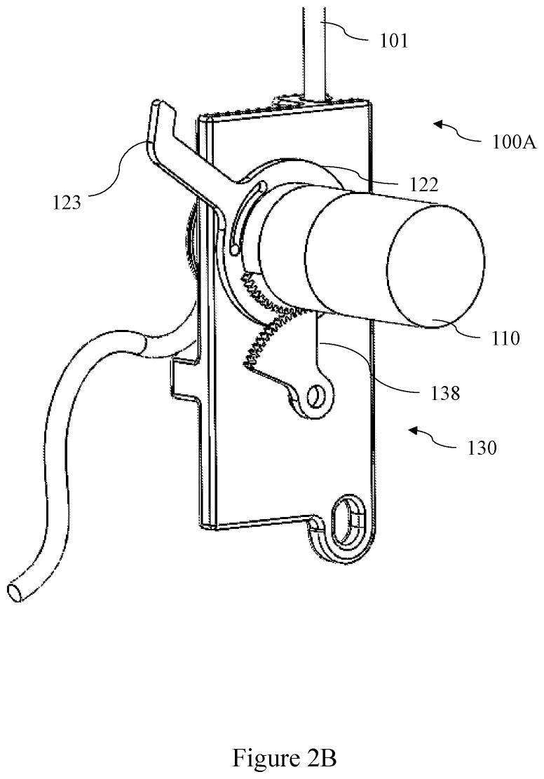

FIGS. 2A and 2B show another embodiment of the powered ascender 100A having a vertical pulley arrangement 140A. As the motor 110 rotates in the forward direction, the motor 110 rotates the pulley 141, causing the powered ascender 100A to ascend the cordage 101. The clamp bar 133 does not apply a braking force to the cordage 101 because the clutch 131 spins freely. When the motor 110 stops, the cordage 101 applies a reverse rotational force to the pulley 143. As the pulley 143 rotates in the reverse direction, the clutch engages the pulley 143, rotating the clamp bar 133 toward the stopper bar 135, generating a maximum clamp bar force on the cordage 101. When the motor 110 rotates in the reverse, the motor mount 122 rotates, moving the gear assembly, which rotates the clamp bar 133 away from the stopper bar 135. As the motor 110 increases the reverse rotation, the clamp bar force decreases. As illustrated, the motor mount 122 includes a manual release handle 123, allowing a user to rotate the motor mount 122 manually to control descent.

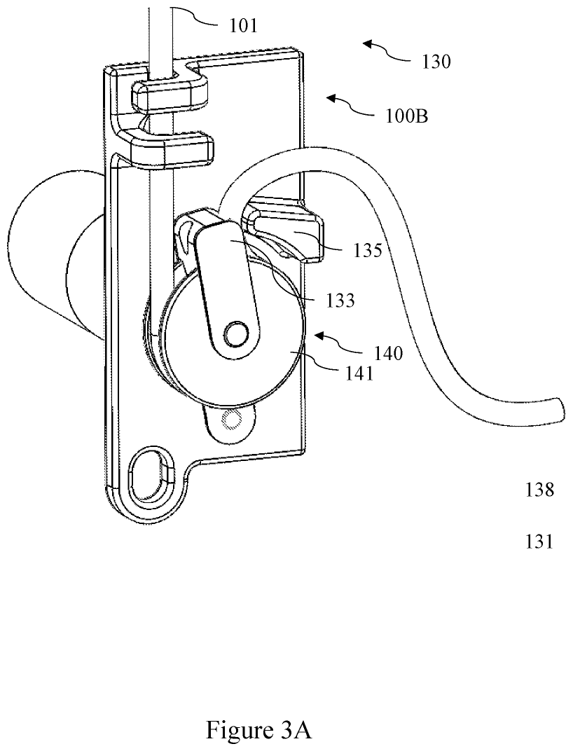

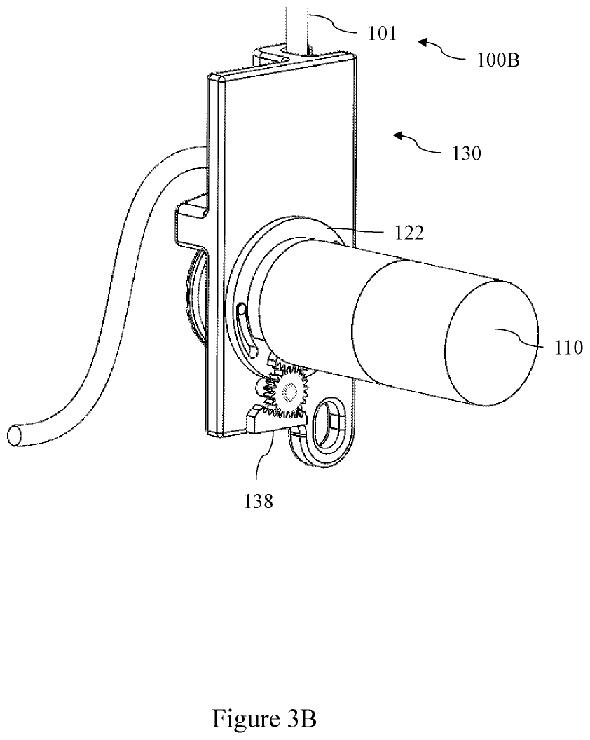

FIGS. 3A and 3B show another embodiment of the powered ascender 100B having a single pulley 141. For the powered ascender 100 to ascend, the motor 110 rotates in the forward direction, exerting a rotational force on the pulley 141 in the forward direction. For the powered ascender 100 to descend, the motor 110 reverses direction, causing the motor mount 122 to rotate, which in turn cause the gear assembly 138 to rotate, and the clamp bar 133 to rotate.

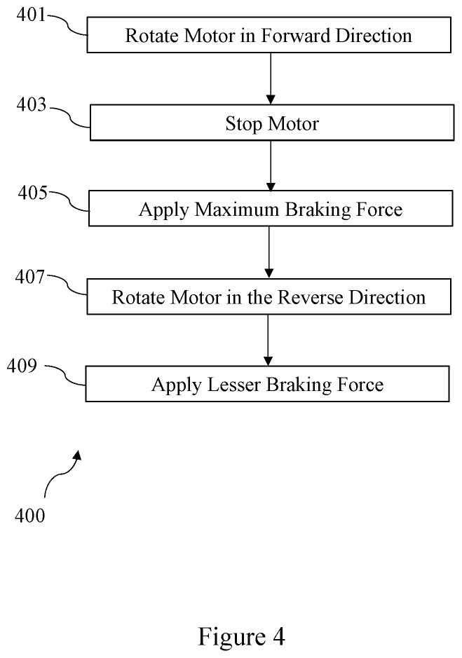

FIG. 4 shows an exemplary process 400 for operating the powered ascender 100. It should be appreciated that a number of variations and modifications to the process 400 are contemplated including the omission of one or more aspects of the process 400, the addition of further conditionals and operations, or the reorganization or separation of operations and conditionals into separate processes, among other things. For example, in the process 400, the powered ascender 100 is operated to ascend the cordage 101, stop, and then descend the cordage 101; however, in other embodiments, the powered ascender 100 may perform the steps to only ascend or only descend, among other things.

The process 400 begins by rotating the motor 110 in a forward direction in operation 401, effectively causing the powered ascender 100 to ascend the cordage 101. When the motor 110 rotates in the forward direction, the clutch 131 engages the pulley 141, exerting a forward rotational force on the pulley 141. At the same time, the clutch 134 disengages from the pulley 141, allowing the driveshaft 121 to rotating without corotating the stoper bar 135.

The process 400 then proceeds to operation 403, where the motor 110 stops rotating in the forward direction. When the motor 110 stops rotating, the cordage 101 exerts a reverse rotational force on the pulley 141. As the pulley 141 rotates in the reverse direction, the clutch 131 disengages from the pulley 141 and the clutch 134 engages the pulley, allowing the rotation of the pulley 141 in the reverse direction to rotate the clamp bar 133 toward the stopper bar 135.

As the clamp bar 133 rotates towards the stopper bar 135, the process 400 applies the maximum braking force to the cordage 101 in operation 405. The maximum braking force is proportional to the weight of the load.

The process 400 then rotates the motor 110 in the reverse direction in operation 407. As the motor 110 rotates in the reverse direction, the driveshaft 121 remains stationary or substantially stationary, being held in place by the force acting upon pulley 142 by the cordage 101. Instead, the motor 110 begins to rotate the motor mount 122.

The process 400 then applies a lesser braking force to the cordage 101, allowing the motor 110 to control the rate of descent of the powered ascender 100. The powered ascender 100 uses the motor to control the rotation of the motor mount 122 to control the rate of descent. As the angular displacement of the motor mount 122 increases, the braking force decreases, thus increasing the rate of descent. As the motor mount 122 rotates, the gear assembly 138 rotates, which in turn rotates the clamp bar 133 away from the stopper bar 135.

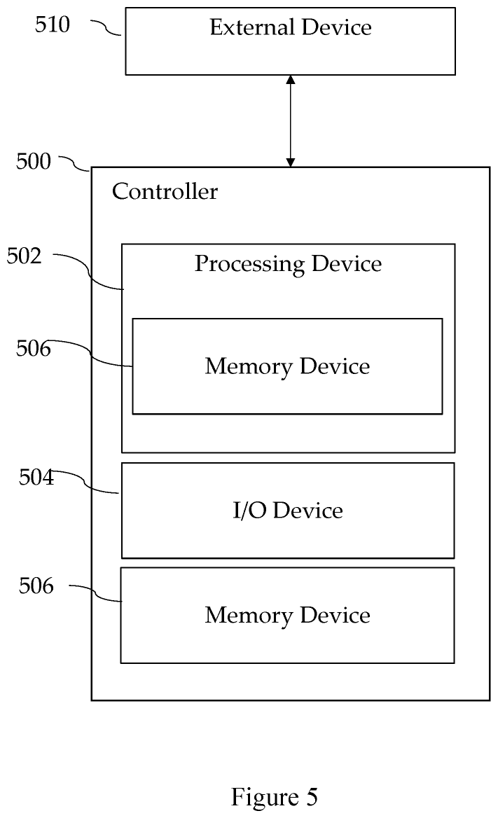

FIG. 5 schematically shows a controller 500 of the powered ascender 100 in accordance with various embodiments. The controller 500 is one example of a computing device which is used to perform one or more operations of the process 400 illustrated in FIG. 4 using the powered ascender 100. The controller 500 includes a processing device 502, an input/output device 504, and a memory device 506. The controller 500 may be a stand-alone device, an embedded system, or a plurality of devices configured to perform the functions described with respect to one of the components of the powered ascender 100. Furthermore, the controller 500 may communicate with one or more external devices 510.

The input/output device 504 enables the controller 500 to communicate with an external device 510. For example, the input/output device 504 may be a network adapter, a network credential, an interface, or a port (e.g., a USB port, serial port, parallel port, an analog port, a digital port, VGA, DVI, HDMI, FireWire, CAT 5, Ethernet, fiber, or any other type of port or interface), among other things. The input/output device 504 may be comprised of hardware, software, or firmware. The input/output device 504 may have more than one of these adapters, credentials, interfaces, or ports, such as a first port for receiving data and a second port for transmitting data, among other things.

The external device 510 may be any type of device that allows data to be input or output from the controller 500. For example, the external device 510 may be a motor, buttons, switches, or a power supply of the powered ascender 100 configured to supply power to the motor 110, among other things. Furthermore, the external device 510 may be integrated into the controller 500. More than one external device may be in communication with the controller 500.

The processing device 502 may be a programmable type, a dedicated, hardwired state machine, or a combination thereof. The processing device 502 may further include multiple processors, Arithmetic-Logic Units (ALUs), Central Processing Units (CPUs), Digital Signal Processors (DSPs), or Field-programmable Gate Arrays (FPGA), among other things. For forms of the processing device 502 with multiple processing units, distributed, pipelined, or parallel processing may be used. The processing device 502 may be dedicated to performance of just the operations described herein or may be used in one or more additional applications. The processing device 502 may be of a programmable variety that executes processes and processes data in accordance with programming instructions (such as software or firmware) stored in the memory device 506. Alternatively or additionally, programming instructions are at least partially defined by hardwired logic or other hardware. The processing device 502 may be comprised of one or more components of any type suitable to process the signals received from the input/output device 504 or elsewhere, and provide desired output signals. Such components may include digital circuitry, analog circuitry, or a combination thereof.

The memory device 506 in different embodiments may be of one or more types, such as a solid-state variety, electromagnetic variety, optical variety, or a combination of these forms, to name but a few examples. Furthermore, the memory device 506 may be volatile, nonvolatile, transitory, non-transitory or a combination of these types, and some or all of the memory device 506 may be of a portable variety, such as a disk, tape, memory stick, or cartridge, to name but a few examples. In addition, the memory device 506 may store data which is manipulated by the processing device 502, such as data representative of signals received from or sent to the input/output device 504 in addition to or in lieu of storing programming instructions, among other things. As shown in FIG. 5, the memory device 506 may be included with the processing device 502 or coupled to the processing device 502, but need not be included with both.

It is contemplated that the various aspects, features, processes, and operations from the various embodiments may be used in any of the other embodiments unless expressly stated to the contrary. Certain operations illustrated may be implemented by a computer executing a computer program product on a non-transient, computer-readable storage medium, where the computer program product includes instructions causing the computer to execute one or more of the operations, or to issue commands to other devices to execute one or more operations.

While the present disclosure has been illustrated and described in detail in the drawings and foregoing description, the same is to be considered as illustrative and not restrictive in character, it being understood that only certain exemplary embodiments have been shown and described, and that all changes and modifications that come within the spirit of the present disclosure are desired to be protected. It should be understood that while the use of words such as “preferable,” “preferably,” “preferred” or “more preferred” utilized in the description above indicate that the feature so described may be more desirable, it nonetheless may not be necessary, and embodiments lacking the same may be contemplated as within the scope of the present disclosure, the scope being defined by the claims that follow. In reading the claims, it is intended that when words such as “a,” “an,” “at least one,” or “at least one portion” are used there is no intention to limit the claim to only one item unless specifically stated to the contrary in the claim. The term “of” may connote an association with, or a connection to, another item, as well as a belonging to, or a connection with, the other item as informed by the context in which it is used. The terms “coupled to,” “coupled with” and the like include indirect connection and coupling, and further include but do not require a direct coupling or connection unless expressly indicated to the contrary. When the language “at least a portion” or “a portion” is used, the item can include a portion or the entire item unless specifically stated to the contrary. Unless stated explicitly to the contrary, the terms “or” and “and/or” in a list of two or more list items may connote an individual list item, or a combination of list items. Unless stated explicitly to the contrary, the terms “have,” “has,” or “having” are open-ended terminology, bearing the same meaning as the transitional term “comprising.”

What is claimed is:

1. A powered ascender, comprising:
a motor;
a brake assembly; and
and a gearbox mechanically coupled between the motor and the brake assembly, wherein the brake assembly is configured to:
apply a maximum braking force while the motor is not rotating, and
apply a lesser braking force in response to the motor rotating in a reverse direction.

2. The powered ascender of claim 1, comprising:
a motor mount configured to rotate in the reverse direction in response to the motor rotating in the reverse direction.

3. The powered ascender of claim 2, wherein a magnitude of the lesser braking force is proportional to a reaction torque of the reverse rotation of the motor.

4. The powered ascender of claim 2, wherein the brake assembly includes:
a gear assembly coupled to the motor mount; and
a clamp bar coupled to the gear assembly.

5. The powered ascender of claim 4, wherein the gear assembly is configured to rotate the clamp bar in response to the motor mount rotation.

6. The powered ascender of claim 1, including a pulley configured to apply a force to a cordage proportional to a weight of a load coupled to the powered ascender.

7. The powered ascender of claim 1, comprising:
a driveshaft;
a pulley; and
a clutch coupled to the driveshaft and configured to selectively engage the pulley.

8. The powered ascender of claim 7, comprising:
a second clutch coupled to the braking assembly and configured to selectively engage the pulley.

9. The powered ascender of claim 8, wherein the pulley is configured to engage the second clutch and disengage from the first clutch when the motor is not rotating.

10. The powered ascender of claim 8, wherein the pulley is configured to disengage from the second clutch and engage the first clutch when the motor is rotating in a forward direction.

11. A method for operating a powered ascender, comprising:
rotating a motor in a forward direction, the motor being coupled to a gearbox;
stopping the motor;
applying, using a brake assembly, a maximum braking force to a cordage;
rotating the motor in a reverse direction; and
applying, using the brake assembly, a lesser braking force after rotating the motor in the reverse direction.

12. The method of claim 11, wherein applying the lesser braking force includes rotating a motor mount in the reverse direction.

13. The method of claim 12, wherein a magnitude of the lesser braking force is proportional to an angular displacement of the rotation of the motor mount.

14. The method of claim 12, wherein the brake assembly includes:
a gear assembly coupled to the motor mount; and
a clamp bar coupled to the gear assembly.

15. The method of claim 14, wherein applying the lesser braking force includes rotating the clamp bar using the gear assembly.

16. The method of claim 11, wherein applying the lesser braking force includes decreasing a magnitude of the lesser braking force by increasing a rotational force of the motor in the reverse direction.

17. The method of claim 11, wherein the powered ascender includes a driveshaft, a pulley, and a clutch coupled to the driveshaft and configured to selectively engage the pulley.

18. The method of claim 17, wherein the powered ascender includes a second clutch coupled to the braking assembly and configured to selectively engage the pulley.

19. The method of claim 18, wherein applying the maximum braking force includes engaging the pulley and the second clutch, and disengaging the pulley and the first clutch.

20. The method of claim 18, wherein rotating the motor in the forward direction includes disengaging the pulley and the second clutch and engaging the first clutch and the pulley.
